(19) United States
(12) Patent Application Publication
(10) Pub. No.: US 2010/0100474 A1
(43) Pub. Date: Apr. 22, 2010

(54) METHODS OF DETERMINING TRANSACTION PRICES ON ELECTRONIC TRADING EXCHANGES

(76) Inventor: Oakley E. Van Slyke, San Clemente, CA (US)

Correspondence Address: Myers Andras Sherman LLP, 19900 MacArthur Blvd., Suite 1150, Irvine, CA, 92612, US

(21) Appl. No.: 12/603,102

(22) Filed: Oct. 21, 2009

Related U.S. Application Data
(60) Provisional application No. 61/196,851, filed on Oct. 21, 2008.

(51) Int. Cl. G06Q 40/00

(52) U.S. Cl. 705/37

(57) ABSTRACT

A method of determining transaction prices on an electronic trading floor, or exchange, requires every participating trader to maintain a bid for each share being traded on the exchange except for those shares held by the trader. Bids are maintained in an electronic database, but not disclosed to traders. When a trader desires to liquidate a share, whether asset or liability, the method enables the trader to liquidate at the most favorable bid. Trading is thus accomplished on the electronic floor without using any offers and without disclosing bids.

### CROSS REFERENCE TO RELATED APPLICATIONS

This application relates to and claims priority from the following U.S. Provisional Application Ser. No., the disclosure of which is incorporated herein by reference as if fully set forth:

1) 61/196,851 filed on Oct. 21, 2008 entitled “METHODS OF DETERMINING A TRANSACTION PRICE ON A CONTRACTS EXCHANGE”;

### FIELD OF THE INVENTION

The present invention relates generally to trading contracts and particularly to transaction prices for contracts.

### DESCRIPTION OF THE PRIOR ART AND RELATED INFORMATION

Traditional trades on conventional stock and futures exchanges require both a bid and an offer. A “bid” is an expression of willingness to buy a specified number of shares at a specified price. An “offer” is an expression of willingness to sell a specified number of shares at a specified price. This price is called the asking price, or simply “ask”. Typically bids and offers have expiration dates or may be withdrawn if not accepted. Often the bid is less than the ask; the difference in price is called the bid-ask spread, or simply “the spread”. A transaction occurs when a bid for a sufficient number of shares is at the asking price for a specified number of shares. Many transactions are accomplished “at the market”, that is, the seller agrees to sell a specified number of shares to the highest bidders or a buyer agrees to buy a specified number of shares at the lowest asking prices. The bid-ask spread is a signal that the volume of transactions may be less in the near future than in the past.

Often, the spread between the bid and ask is wide, leading to a stock or contract being thinly traded or not at all. Such lack of trading activity impairs the ability of investors, farmers, producers and consumers to make effective, efficient decisions. In general, liquidity is the ability to dispose of an asset or contractual liability without disruptions of any kind. Liquidity is the oil of the financial economy. Liquidity keeps the economy running smoothly. The loss of liquidity creates problems large and small. In a particular market sector such as rice, a loss of liquidity typically leads to high prices and long waiting lines. In a global economy, a loss of liquidity can put millions of people out of work: the loss of liquidity for the assets of banks was the proximate cause of the global recession of 2007-2009, according to Nobel Laureate economist Paul Krugman and others.

The custom of determining price using bids and offers creates other problems. The practice creates the opportunity for firms to acquire large blocks of stock and bonds at low prices or not at all as well as creating the opportunity for management to push up the price of a company's stock by buying it with employee savings plans and executive bonuses. Bubbles in prices and the resulting crashes have their own costs as they disrupt supply lines, employment practices and financial plans.

Another problem of increasing importance in the current decade is the effect of a loss of liquidity on market prices. A loss of liquidity implies an increase in the demand for cash, a fall in asset prices and an increase in valuations of liabilities. Businesses that value assets and liabilities using market values see a sudden decline in the valuations of their assets and a sudden increase in the volatility of measures of performance such as earnings. When liquidity has been lost, companies are undervalued, their operations are less profitable and the economy suffers. These effects are magnified by the increasing use of mark-to-market accounting.

### SUMMARY OF THE INVENTION

Systems and methods described herein overcome the deficiencies in the prior art. In one aspect, a method of determining a transaction price on an exchange is provided. The method comprises maintaining a first record identifying for each share that is listed on the exchange an identity of a corresponding trader that owns said share. Each trader is required to maintain a bid for each individual share listed on the exchange which is not owned by each trader. The method comprises maintaining a second record of all bids for each share.

The method further comprises performing a maintenance cycle at a stated interval. The stated interval preferably comprises a steady frequency which operates substantially continuously without stopping. The stated interval is preferably less than a second. The first and the second records may be included in the same database or in different databases.

The method further comprises requiring after a close of a transaction that a selling trader enter a bid for the share just sold. Each trader is permitted to change each of its bids at a given time. The method further comprises enabling each trader to liquidate each held share at a most favorable bid for each held share. The method further comprises publishing ownership data for shares without disclosing which of several identical shares are owned by a corresponding trader. The method further comprises ordering one of a plurality of traders to liquidate a particular held share at a most favorable bid. The method further comprises applying an algorithm to the first and second records to create a message to one of a plurality of traders. The method further comprises applying an algorithm to data from outside the exchange to create a message to one of a plurality of traders. The method further comprises trading shares of liquid insurance contracts on the exchange.

All bids are preferably kept confidential. Each trader is enabled to disguise its strategy using randomized bids and liquidation orders. No limits are imposed on each trader's positions. The shares being traded on the exchange may comprise listed short positions.

The method further comprises requiring each trader to limit its positions to shares that are on a list maintained by the exchange. The method further comprises operating the exchange with transparent traders. The method further comprises publishing a list of transactions showing prices for individual identical shares. The method further comprises publishing a list of transactions that does not identify any party to a transaction.

In another aspect, a method of determining a transaction price on an exchange comprises maintaining a first record showing for each share that is listed on the exchange an identity of a corresponding trader that owns said share, requiring each trader to maintain a bid price for all shares being traded on the exchange which are not owned by each trader, maintaining a second record identifying all bid prices for each share, and trading each share listed on the exchange without receiving an offer.

All bids are kept confidential from traders. The method further comprises ordering one of a plurality of traders to liquidate a particular share at a most favorable bid. No limits are imposed on each trader's positions. The exchange may comprise a liquid insurance contract (LIC) exchange. The method further comprises requiring each trader on the exchange to have substantially all holdings marked to market.

In a further aspect, a method of determining a transaction price on an electronic trading exchange comprises enabling each trader to liquidate each held share at a most favorable bid for each held share, maintaining a first record showing for each share that is listed on the exchange an identity of a corresponding trader that owns said share, requiring each trader to maintain a bid price for all shares being traded on the exchange which are not owned by each trader, and maintaining a second record identifying bid prices for each share.

The method further comprises trading shares listed on the exchange without using any offers. The method further comprises excluding traders from using margin accounts. The method further comprises imposing no limits on each trader's positions. The exchange comprises a liquid insurance contract (LIC) exchange. The method further comprising requiring each trader on the exchange to have substantially all holdings marked to market.

In another aspect, an electronic system for determining the price of a transaction is provided. The system comprises an exchange, a plurality of traders, confidential messages between the exchange and one of the plurality of traders, a report showing for the plurality of traders each trader's ownership interests in items traded on the exchange, and a list of transactions showing prices for individual identical shares. The list of transactions does not include identifying information about the parties to the transaction.

In a further aspect, a method of determining transaction prices on an electronic trading floor, or exchange, requires every participating trader to maintain a bid for each share being traded on the exchange except for those shares held by the trader. Bids are maintained in an electronic database, but not disclosed to traders. When a trader desires to liquidate a share, whether asset or liability, the method enables the trader to liquidate at the most favorable bid. Trading is thus accomplished on the electronic floor without using any offers and without disclosing bids.

### BRIEF DESCRIPTION OF THE DRAWINGS

FIG. 1 illustrates a preferred embodiment of an electronic trading system using a preferred method of determining a transaction price.

### DETAILED DESCRIPTION OF THE PREFERRED EMBODIMENTS

The various embodiments can now be better understood by turning to the following detailed description. It is to be expressly understood that the illustrated embodiments are set forth as examples and not by way of limitations on the invention as ultimately defined in the claims.

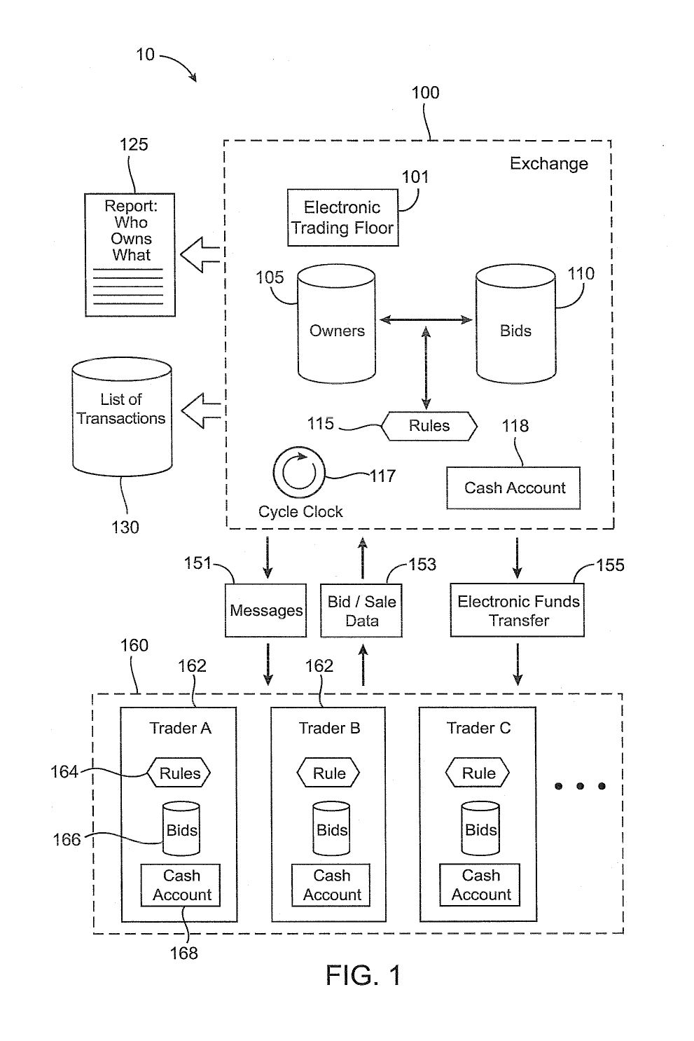

FIG. 1 illustrates a preferred embodiment of an electronic trading system 10. The system 10 uses methods of determining price on an exchange 100 which includes an electronic trading floor 101.

An electronic trading floor 101 according to the preferred embodiment may trade any of several items. Typically these are shares of common stock or preferred stock, or are commodity futures contracts or options on stock or futures contracts. Herein, the term “share” refers to an item traded on an electronic trading floor. For example, a “share” might be a contract for pork bellies, but a “share” would not denote the hog itself.

A share may also be a contract to sell a fraction of an asset at a designated future time, or a contract to assume a fraction of a liability at a designated future time. In practice, then, a share could be a small short position offsetting an unspecified listed share. For example, the exchange 100 could list one million shares of XYZ Corporation, or alternatively it could list 1.3 million shares and 0.3 million short positions which are also traded as shares.

A “sale” herein refers to an order from the owner of a share to sell that share to the highest bidder. It is similar to a order to sell shares at the market price but is for a specific share rather than for a stated number of shares.

A “call” herein refers to an order by the electronic trading floor for the owner of a share to sell that share to the highest bidder.

In FIG. 1, the exchange 100 comprises the electronic trading floor 101, records of which traders own which shares 105, records holding the bids received from the traders 110, rules encoded in software 115, a cycle clock 117, a cash account 118, and channels of communication.

The exchange 100 operates for and with a set of traders 160. Each trader 162 denoted by a unique identifying number or signature comprises decision rules encoded in software 164, an electronic record of bids to submit 166, and a cash account 168. Traders may differ from one another in other ways.

The preferred embodiment of the system 10 eliminates the need for offers from traders and minimizes the disruption that might arise from any transaction by having trading done separately for each individual share listed on the exchange 100 in the context of having many identical shares as well as many similar but different shares. The typical transaction price is a few dollars, perhaps a few hundred dollars, and the number of transactions is correspondingly greater. Rather than an offer to sell a share if a certain price is paid, the seller simply declares to the exchange 100 its order to sell, and the sale is done; the exchange 100 has committed to securing a bid from each other trader and to providing the most favorable bid to the seller.

The preferred embodiment of the system 10 mitigates price bubbles and crashes typical of stock exchanges by making possible small naked short positions. No one short position runs a risk of becoming financially disruptive, and the preferred embodiment assures that every naked short position can be liquidated on a moment's notice.

The preferred embodiment is made practical by modern data processing technology. Although less demanding than intensive applications such as Google or Google Earth, the system requires today's databases and data transfer rates. The system uses a novel set of large data records and high-speed communications to create many transactions none of which is disruptive.

In a preferred method of determining the price, each trader 162 is required to maintain a bid for each share listed on the exchange 100, except for those shares already held by the trader.

The exchange 100 maintains a record 110 of all bids that are currently in place, which thus comprises all bids for each share listed on the exchange. In the preferred embodiment, this may include an electronic array showing for each of billions of shares the bid of each of the hundreds or thousands of traders. Moreover, in the preferred embodiment, bid record 110 is stored globally and kept up to date without interruption. In the preferred embodiment, the contents of the bid record 110 is known only to the exchange 100 and not to the traders.

The record of bids 110 may be a two-dimensional array that mirrors the bid-owned arrays of the traders. This is updated at the beginning of each interval or cycle. To illustrate, if there are 1000 traders, 4,000,000,000 shares listed, and each bid is stored using 8 bytes of memory, the number of bids is approximately 4 million million, and the number of bytes in the array is 32 million million, so the array is about 32 terabytes.

The following is an example of a sale of an asset according to the preferred method:
The exchange 100 has listed on the electronic trading floor 101 one million shares of XYZ Corporation common stock with serial numbers from 1,000,001 to 2,000,000.
There are one thousand traders 160 enabled to trade on the electronic trading floor 101, one of which is named Trader A and one of which is named Trader B.
Trader A owns 10,212 of the listed shares of XYZ Corporation. This is reported in the public report of ownership 125.
The transactions list 130 shows that shares of XYZ have recently been selling for about $330.00.
Trader A values its shares of XYZ at $330.00 each. This is not shown in FIG. 1.
Trader B owns 128 of the shares of XYZ. This, too, appears in the report of ownership 125.
Trader A maintains a bid for each of the shares it does not own; the bids by Trader A vary around $330, ranging from $270 to $340.50. These bids 166 are confidential; they are confidentially communicated 153 to the exchange 100 via the Bid/Sale Data 153 and stored in the exchange's record of bids 110.
Each of the one million shares has 999 bids in the record of bids (a total of one thousand traders, but one trader is the owner); the bids range from $0.01 to $345.00.
Each of the one million shares has a unique highest or most favorable bid in the record of bids 110. The most favorable bid for a particular share will be the transaction price if the owner sells that share. Across the one million shares, the most favorable bids range from $300.00 to $330.00.
Trader B sells (issues a sell order for) one of its shares of XYZ, the share bearing serial number BB000016. This is documented in its record of bids 166 and communicated to the exchange in the bid/sale data 153. Trader B also includes a bid price for share BB000016 of $298.00 so that if a trader picks it up by mistake and promptly sells it Trader B will pick up an expected gain of about thirty dollars if it finds itself holding the share again.
During the following maintenance cycle, the exchange 100 notes the sale instruction, looks up the highest bid for the share with serial number BB000016, finds that the highest bid is from Trader A for $328.50, records that Trader A now is the owner of that share, and issues electronic funds instructions moving $328.50 from the Cash Account of Trader A to the cash account of Trader B.
Trader B may continue to sell its shares; it may sell every share of XYZ in a single order (but not know the price) or sell them pursuant to its internal decision rules 164.

In the preferred embodiment, the exchange 100 requires each trader 162 to maintain a bid for each individual share that is listed on the exchange 100, excepting only the shares that the trader already holds. These bids are stored in a record 166 which is sent 153 to the exchange 100 once in each maintenance interval. While the exchange 100 may impose constraints on those bids, those bids are not constrained in the preferred embodiment, except for such constraints as are required by the information technology.

The exchange 100 permits each trader 162 to change each of its bids. In the preferred embodiment, there are no constraints on the frequency of changes, except for such constraints as are required by the information technology. In the preferred embodiment, each trader 162 maintains a data processing facility with its bid record 166 physically near to a data processing facility operated by the exchange 100 so that communication times for step 153 are kept to a minimum. Traders may employ methods of game theory including randomized sell orders and bid prices; one reason to do so is to provide a means of disguising their strategies.

A trader 162 may change its bid and sale data once in each maintenance interval. In the preferred embodiment, the exchange 100 operates without interruption. The maintenance interval may be set by a schedule or may be on a steady cycle. In the preferred embodiment there is a steady cycle kept by a cycle clock 117. The maintenance interval may be long enough to be meaningful to human perception or be so brief that it is only available to electronic interaction. In the preferred embodiment the maintenance cycle is a fraction of a second, e.g., 1/50^{th} of a second.

The preferred method of trading works without offers. To sell shares, the trader 162 would simply send sell orders for one or more specific shares and be paid the most favorable price currently existing for each particular share. This may be combined in a single submission of bids 153, or spread out over a series of communications 153 using decision rules 164 the trader 162 has stored in its system. Furthermore, in the preferred embodiment bids are maintained confidentially; accordingly, although a trader will not know the bid price for any particular share prior to the sale, the trader will know the recent prices of other identical shares and will have complete assurance that the sale requested confidentially in the bid/sale data 153 will occur in the next maintenance cycle.

The exchange 100 may require the seller of a specific share to place a bid for that share that will be included in the record of bids 110 when the seller no longer holds said share. For example, the trader who values a share at $330.00 might direct the sale of a specified share followed by a $300.00 bid for that same share. If this trader is right about the price, the trader will break even on the sale, and if the particular share is quickly resold (an event over which this trader has no control), the trader may have the share (if there is no bid above $300.00) and be $30 richer for it. The exchange 100 may impose different constraints on such bids from the requirements on other bids, including but not limited to a default bid that is a function of the sale price in that transaction.

Shares of common stock are recorded as assets, but more generally shares of contracts are recorded as either “assets” or “liabilities” on the balance sheets of the traders. Shares of contracts for which the estimated market price is positive are called assets. A trader expects to receive cash when it liquidates an asset. Shares of contracts for which the estimated market price is negative, that is, a payment by the holder, are called liabilities. A trader expects to pay cash when it liquidates a liability. A “bid” in the case of a liability is a cash amount sufficiently large that a trader would be willing to acquire the liability along with the cash.

The trader is permitted to liquidate any share it holds at the most favorable bid, namely, highest price for an asset or least amount to pay to liquidate a liability. In the preferred embodiment, there are no constraints except for such constraints as are required to maintain the databases. The exchange 100 may have the right to a fee for such a transaction.

The trader may include any number of sales in its bid/price data 153. A trader may include sales of both assets and liabilities in a single data submission in order to minimize the effect of selling on its cash account 168. Alternatively, a trader wishing to increase the balance in its cash account may include directions to sell assets and to reduce the premiums it would charge for liabilities (that is, make its bids more favorable and more likely to be the winning bid). In a further alternative, a trader wishing to reduce its exposure to economic events may sell both assets and liabilities and reduce its bids to make them less likely to be the winning bid.

In the preferred embodiment, because of the volume of activity (e.g., assimilating one million new bids from each of 999 traders in each maintenance interval based on the asset sale example above) the trader may employ decision rules 164 which are stored electronically to determine its bids 166 in light of the public report of ownership 125 and the public list of transactions 130.

The preferred embodiment promotes the ability of every trader to liquidate any position with minimal disruption of any kind by ensuring that every trader's positions are being held only temporarily. Accordingly, under generally accepted accounting practices the trader's holdings would be valued preferably using the accounting method known as “mark to market”. That accounting method requires a trader holding two or more identical shares to mark them to the same estimate of market price. That method also requires each trader to estimate that market price using transaction data when available. With the mark-to-market method, on average the proceeds of sales preferably will be the same as the estimates of market value, and overall the selling of shares will not lead to an expectation of either gains or losses.

The exchange 100 may charge a fee for processing sell orders. In the preferred embodiment the fees would be so small in relation to the share price that the fees would not discourage sales activity. Technically, if shares are marked to market so there is on average no gain or loss arising from a sale, the payment of fees for sell orders implies that the sell orders provide the sellers sufficient reduction in uncertainty that the sellers are better off to have paid the fees than to keep the uncertainty.

The feature that promotes this is that the sale prices of individual shares are not financially significant except for the information those prices provide to the estimate of the market value of every similar share. In the example of XYZ Corporation a sale of a share for $328.50 could not have substantially changed the balance sheet of Trader B because trader B holds only 127 other shares of XYZ Corporation; the transaction has a much greater effect on Trader A because Trader A holds more than 10,000 shares of XYZ and marks those shares to their market price. Moreover, there may be thousands of small transactions on XYZ's shares in a given day.

The bid prices and sale orders minimize disruptions of any kind by a) keeping each transaction small; b) providing a steady stream of transaction data; c) keeping a range of bids in place for each particular share d) keeping an exponentially greater range of bids in place for the identical shares that comprise a given listing.

The preferred embodiment has additional features that promote liquidity by minimizing disruptions of any kind. One of these features is that the exchange 100 has the right and the ability to inspect the record of bids 110, to maintain rules 115 that reflect a wide range of data including the entire history of transactions, and to issue confidential messages to the traders 151. The publicly available list of transactions 130 may provide the public only part of the information available to the exchange 100. Using this feature the exchange 100 may be able to detect when the market for a certain contract is at risk of becoming illiquid and take steps to minimize disruptions of any kind.

For example, the exchange 100 might observe that the record of bids 110 begins to show a price band in which bids are relatively absent, specifically, that only Trader Q is bidding for XYZ in the price range from $240 to $270, and that other traders are placing bids above $270 or below $240. This observation might suggest that the existing owners would be well off to make bids in the range of $240 to $270 and sell their current holdings. This confidential information could be used to create messages 151 to the trader community 160 to stimulate such selling and bidding.

In the preferred embodiment, the exchange 100 also has a right to order the liquidation of any particular share for the most favorable bid. An order to sell a particular share at the most favorable price is a “call”. The transaction for a “call” may look just the same as for a “sell”; in the preferred embodiment only the exchange and the trader would know the transaction began with a call. In the preferred embodiment, the exchange 100 charges the trader a lower fee, or none at all, for processing a call. In the preferred embodiment the public information does not distinguish between calls and voluntary sales.

Upon receiving a message from the exchange 151 or detecting a change using its rules 164, it is in the self-interest of each trader that understands that contract to revise its bids 166. Messages, sales and calls guide each trader to maintain realistic bids. The mere ability to issue calls provides traders with an incentive to keep bids active to take advantage of such calls.

The purpose and effect of calling a share is to minimize disruptions in the pattern of prices in the list of transactions. A history of prices that has been minimally disrupted by any transaction might appear as ups and downs as a given opportunity becomes more or less popular, surrounded by apparently random fluctuations from one transaction to the next.

As information changes, the traders revise their bids for the shares. These revisions generally minimize disruptions, but the revised bids may increase the chance of a disruption. The following are some exemplary criteria or conditions which might trigger the exchange 100 to call a share:

1) In the event that the exchange 100 observes that there is now a lack of bidding activity near the market price for the shares of a particular contract, the exchange 100 calls for one of the shares of that contract to be sold, perhaps the share with the lowest most favorable price. The transaction price could signal to the traders a possible sudden change in the “market price” for all of the shares of that contract. It also signals a possible set of shares for which no trader has made an active market.

2) Using a measure of volatility of share prices, the exchange 100 might determine (using bid data 110 available only to the exchange 100) that the volatility of share prices is likely to increase quickly (e.g., to fail some threshold of stability).

3) A wide range of mathematical algorithms have been developed to detect changes in large data arrays, including genetic algorithms, bootstrap methods of re-sampling, and generalized linear modeling.

The exchange 100 may apply algorithms to the records of owners 105, the records of bids 110, the cash accounts (118, 168), the list of transactions and any other relevant data, identifying changes and sending signals to the exchange's decision rules 115, in turn triggering messages perhaps including calls 151 and perhaps altering the decision rules 115 themselves.

Upon receiving a message from the exchange 151 or detecting a change using its rules 164, it is in the self-interest of each trader that understands that contract to revise its bids 166. Both sales and calls guide each trader to maintain realistic bids.

The exchange 100 can act as a clearing house, or have a financial interest in a clearing house that it contracts with, realizing the profits and losses of this business activity. Acting as a clearing house, it can charge a fee for its services. Fees can be assessed as often as practical, perhaps averaging (by way of example) thirty minutes from the report of the trade until the collection of the clearing fee.

The exchange 100 can operate with settlements essentially continuously. This might be accomplished by contracts through a worldwide bank or network of banks sufficiently broad to permit clearing of payment transactions essentially continuously and essentially globally. The exchange 100 can be paid a fee by such bank or banks. The exchange 100 can maintain lists of contracts and securities that it deems liquid;

it can charge a fee for access to this list. The exchange 100 might deem liquid for example: notes and bonds issued by governments, central banks, corporations or public agencies that are widely and frequently traded. The exchange 100 might deem liquid for example reinsurance contracts that are nearly the same as contracts traded on the exchange but that are placed with other parties than the exchange.

The exchange 100 can take actions to promote the liquidity of the shares it trades. These actions involve business methods at least one of which is not a method used by commodity futures contract exchanges today. They include without limitation:
The exchange 100 can sell a performance bond to a listed trader.
The exchange 100 can control or arrange for traders to be market makers which would have authority and responsibility to promote liquidity, including, without limitation: rights to acquire all units of thinly traded contracts; rights to underwrite new issues of contracts; rights to assume risks of loss from other traders of the group 160.
The exchange 100 can require traders or their sureties to grant the exchange certain rights (as, for example, the New York Stock Exchange has the right to de-list stocks that fall below a certain share price).
   The exchange 100 can monitor traders who are not permitted to trade on the exchange as well as those who are.

The following is an example of the exchange monitoring traders who are not permitted to trade on the exchange. A privately owned hedge fund is operating much like a listed trader and is using data from the public records 125, 130 in its decision-making. Monitoring the activities of this hedge fund might be worth the cost of doing so if the hedge fund creates an additional systemic risk for the exchange.

Systemic risk is enormously costly to the economy. President Obama has directed the Administration to develop methods of reducing system risk. Most of the descriptions of the collapse of Long Term Capital Management (LTCM) point out that the counterparties of LTCM's deals were all using the strategy of “following LTCM”. This created a lot of deals, but when a major outside player defaulted, there were no markets to which LTCM could turn. This could have been prevented if LTCM had monitored the activities of other hedge funds and identified the problem.

It will be appreciated that the preferred system 10 and methods of determining transaction prices described above may also be applied to trading bonds, promissory notes, shares in contingent fees or insurance proceeds, shares in limited partnerships, general partnerships, time shares, Tenants in Common, etc. Those familiar with the art will be able to apply this to other kinds of shares that might be exchanged for cash.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different elements, which are disclosed in the above even when not initially claimed in such combinations.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

1. A method of determining a transaction price on an exchange, comprising:
maintaining a first record identifying for each share that is listed on the exchange an identity of a corresponding trader that owns said share;
requiring each trader to maintain a bid for each individual share listed on the exchange which is not owned by each trader; and
maintaining a second record of all bids for each share.

2. The method of claim 1, further comprising:
performing a maintenance cycle at a stated interval.

3. The method of claim 2, wherein the stated interval comprises a steady frequency which operates substantially continuously without stopping.

4. The method of claim 2, wherein the stated interval is less than a second.

5. The method of claim 1, wherein the first and the second records are included in a database.

6. The method of claim 1, further comprising:
requiring after a close of a transaction that a selling trader enter a bid for the share just sold.

7. The method of claim 1, further comprising:
permitting each trader to change each of its bids at a given time.

8. The method of claim 1, further comprising:
enabling each trader to liquidate each held share at a most favorable bid for each held share.

9. The method of claim 1, further comprising:
publishing ownership data for shares without disclosing which of several identical shares are owned by a corresponding trader.

10. The method of claim 1, further comprising:
ordering one of a plurality of traders to liquidate a particular held share at a most favorable bid.

11. The method of claim 1, further comprising:
applying an algorithm to the first and second records to create a message to one of a plurality of traders.

12. The method of claim 1, further comprising:
applying an algorithm to data from outside the exchange to create a message to one of a plurality of traders.

13. The method of claim 1, further comprising:
trading shares of liquid insurance contracts on the exchange.

14. The method of claim 1, further comprising:
keeping all bids confidential.

15. The method of claim 1, further comprising:
enabling each trader to disguise its strategy using randomized bids and liquidation orders.

16. The method of claim 1, further comprising:
imposing no limits on each trader's positions.

17. The method of claim 1, further comprising:
trading shares which comprise listed short positions.

18. The method of claim 1, further comprising:
requiring each trader to limit its positions to shares that are on a list maintained by the exchange.

19. The method of claim 1, further comprising:
operating the exchange with transparent traders.

20. The method of claim 1, further comprising:
publishing a list of transactions showing prices for individual identical shares.

21. The method of claim 20, further comprising:
publishing a list of transactions that does not identify any party to a transaction.

22. A method of determining a transaction price on an exchange, comprising:
maintaining a first record showing for each share that is listed on the exchange an identity of a corresponding trader that owns said share;
requiring each trader to maintain a bid price for all shares being traded on the exchange which are not owned by each trader;
maintaining a second record identifying all bid prices for each share; and
trading each share listed on the exchange without receiving an offer.

23. The method of claim 22, further comprising:
keeping all bids confidential from traders.

24. The method of claim 22, further comprising:
ordering one of a plurality of traders to liquidate a particular share at a most favorable bid.

25. The method of claim 22, further comprising:
imposing no limits on each trader's positions.

26. The method of claim 22, wherein the exchange comprises a liquid insurance contract (LIC) exchange.

27. The method of claim 22, further comprising:
requiring each trader on the exchange to have substantially all holdings marked to market.

28. A method of determining a transaction price on an electronic trading exchange, comprising:
maintaining a first record showing for each share that is listed on the exchange an identity of a corresponding trader that owns said share;
requiring each trader to maintain a bid price for all shares being traded on the exchange which are not owned by each trader;
maintaining a second record identifying bid prices for each share; and
enabling each trader to liquidate each held share at a most favorable bid for each held share.

29. The method of claim 28, further comprising:
trading shares listed on the exchange without using any offers.

30. The method of claim 28, further comprising:
excluding traders from using margin accounts.

31. The method of claim 28, further comprising:
imposing no limits on each trader's positions.

32. The method of claim 28, wherein the exchange comprises a liquid insurance contract (LIC) exchange.

33. The method of claim 28, further comprising:
requiring each trader on the exchange to have substantially all holdings marked to market.

34. An electronic system for determining the price of a transaction, comprising:
an exchange;
a plurality of traders;
confidential messages between the exchange and one of the plurality of traders;
a report showing for the plurality of traders each trader's ownership interests in items traded on the exchange; and
a list of transactions showing prices for individual identical shares.

35. The system of claim 34, wherein:
the list of transactions does not include identifying information about the parties to the transaction.
